(19) United States
(12) Patent Application Publication
(10) Pub. No.: US 2026/0017306 A1
(43) Pub. Date: Jan. 15, 2026

(54) GENERATING PERSONALIZED VIDEO RESPONSES FOR A USER USING INTEGRATED PROGRAMMATIC AND SPECIALIZED GUIDED AND CONSTRAINED ARTIFICIAL INTELLIGENCE

(71) Applicant: 2hr Learning, Inc., Austin, TX (US)

(72) Inventors: Philip Hewinson, Woking (GB); Niraj Patel, Dubai (AE); Akshay Mate, Nanaimo (CA); Sean Carlson

(73) Assignee: 2hr Learning, Inc., Austin, TX (US)

(21) Appl. No.: 19/270,022

(22) Filed: Jul. 15, 2025

Related U.S. Application Data
(60) Provisional application No. 63/671,750, filed on Jul. 15, 2024.

(51) Int. Cl. G06F 16/338; G06F 16/3329; G06T 13/20; G10L 13/027

(52) U.S. Cl. CPC G06F 16/338; G06F 16/33295; G06T 13/205; G10L 13/027

(57) ABSTRACT

A system and method combine programmatic control and a guided and constrained Artificial Intelligence (AI) engine to generate personalized video responses for a user. Receiving user inputs to identify a historical figure and a question directed to the corresponding historical figure. Information about the historical figure, including image, voice identifier, and biographical profile, is retrieved. Under programmatic logic control, an AI engine analyzes a question and generates an excuse for any delay in responding, else generate a dialogue response. The dialogue response is integrated with relevant information to generate a response having an audio and visual component with the voice identifier and dialogue response, and the image of the selected historical figure. A prompt is generated to guide and constrain the AI engine to create a video response that integrating audio and visual components to simulate the historical figure delivering the dialogue response and providing to an online learning platform.

### CROSS-REFERENCE TO RELATED APPLICATION(S)

This application claims the benefit under 35 U.S.C. § 119(e) and 37 C.F.R. § 1.78 of U.S. Provisional Application No. 63/671,750, which is incorporated by reference in its entirety.

### FIELD OF THE INVENTION

The present invention relates in general to the field of electronics, and more specifically to video response generation systems and video response generation methods to generate personalized video responses for the users.

### BACKGROUND OF THE INVENTION

Educational learning platforms define a webspace for educational content and resources that offers students everything they need in one space. The educational learning platform serves as a virtual classroom providing content in different formats such as videos, lectures, interactive quizzes, discussion forums, and downloadable materials. Moreover, the educational learning platforms provide the students the flexibility to learn at their own pace and convenience. The educational platforms are used to facilitate the learning process. Typically, the educational platforms present content to the students using pictorial elements, infographics, and audio-visual clips to complement texts that explain the content or theories. The content not only makes learning fun but also supports different styles.

The content on educational learning platforms can include text-based articles that include quizzes, and polls to engage the students. Moreover, the videos utilized on the educational learning platforms are highly engaging and informative content that can be used to provide educational information. However, the educational content available on the educational learning platforms is static content that offers fixed content in which the users cannot interact and modify the content. Furthermore, the static content often lacks interactive elements making it difficult for the students to stay on the educational learning platforms for an extended period.

Moreover, the traditional content provided on the educational learning platforms relies on one-size-fits-all and assumes that all students learn similarly. However, the traditional content delivered on the educational learning platforms fails to engage students on a personal level, thus leading to a disconnection between the student and the learning material making it challenging for the students to maintain interest and motivation.

Conventionally the historical figures are incorporated in reading textbooks or pre-recorded videos. However, the historical figures do not interact with the students making it difficult to raise questions and get feedback in real-time. The historical figures help to understand the motivation behind their actions and enhance the learning process. Moreover, the historical figures lack the ability to personalize the learning experience or adapt to individual student inquiries in real-time.

### SUMMARY

In at least one embodiment, a method for guiding and constraining an Artificial Intelligence (AI) engine to generate personalized video responses for a user including executing code using one or more processors of a computer system to cause the computer system to perform operations including receiving a user input from the user. The user input identifies a historical figure from a predefined list of historical figures. The operations also include receiving a question input from the user. The question input includes a query directed to the selected historical figure. In addition, the operations include retrieving information relevant to the selected historical figure. The relevant information comprises an image, a voice identifier, and a biographical profile of the selected historical figure. Furthermore, the operations include utilizing a language learning model (LLM) to analyze the question input. The LLM generates an excuse for any anticipated delay in responding to the question input. The LLM also generates a dialogue response formulated based on the biographical profile and historical context of the selected historical figure. Moreover, the operations include integrating the dialogue response with the relevant information retrieved for the selected historical figure to generate response. The response includes an audio component incorporating the voice identifier and the dialogue response. The response also includes a visual component incorporating the image of the selected historical figure. Additionally, the operations include generating a prompt to guide and constrain the AI engine for generating a video response using a video generator. The video response integrates the audio component and visual component to simulate the selected historical figure to deliver the dialogue response. Finally, the operations include transferring the prompt to the AI engine to provide the generated video response to the user on a user interface of an online learning platform.

In another embodiment, a system for guiding and constraining an Artificial Intelligence (AI) engine to generate personalized video responses for a user including one or more processors. It also includes memory, coupled to the one or more processors, storing code that when executed cause the one or more processors to perform operations including executing code using one or more processors of a computer system to cause the computer system to perform operations including receiving a user input from the user. The user input identifies a historical figure from a predefined list of historical figures. The operations also include receiving a question input from the user. The question input includes a query directed to the selected historical figure. In addition, the operations include retrieving information relevant to the selected historical figure. The relevant information comprises an image, a voice identifier, and a biographical profile of the selected historical figure. Furthermore, the operations include utilizing a language learning model (LLM) to analyze the question input. The LLM generates an excuse for any anticipated delay in responding to the question input. The LLM also generates a dialogue response formulated based on the biographical profile and historical context of the selected historical figure. Moreover, the operations include integrating the dialogue response with the relevant information retrieved for the selected historical figure to generate response. The response includes an audio component incorporating the voice identifier and the dialogue response. The response also includes a visual component incorporating the image of the selected historical figure. Additionally, the operations include generating a prompt to guide and constrain the AI engine for generating a video response using a video generator. The video response integrates the audio component and visual component to simulate the selected historical figure to deliver the dialogue response. Finally, the operations include transferring the prompt to the AI engine to provide the generated video response to the user on a user interface of an online learning platform.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary video response generation system to generate personalized video response for a user.

FIG. 2 depicts an exemplary video response generation process utilized by the video response generation system.

FIG. 3 depicts a video response generation process, which is an embodiment of the video response generation process of FIG. 2.

FIG. 4 is a sequential diagram for generating video response, which is an embodiment of the video response generation system of FIG. 1.

FIG. 5 depicts an appropriateness analyzing process for the question input, which is an embodiment of the video response generation process of FIG. 2.

FIG. 6 depicts a data structure used for generating personalized video.

FIG. 7 depicts a data structure used for generating curriculum focused response.

FIG. 8 depicts a data structure used for generating persona response.

FIGS. 9-18 are exemplary user interfaces depicting interaction between the user and the online learning platform.

FIG. 19 depicts a user flow process to generate the video response, which is an embodiment of the video response generation process of FIG. 2.

FIG. 20 depicts an exemplary network environment in which the video response generation system of FIG. 1 and the video response generation process of FIG. 2 may be practiced.

FIG. 21 depicts an exemplary computer system.

### DETAILED DESCRIPTION

The video response generation system and method set forth herein address technical issues with generating personalized video response described herein. Conventionally, manual processes were used to generate the personalized video response and were very tedious and time consuming. The present video response generation system and method utilize an automated system that does not merely automate a manual process or use a conventional system in a conventional way. The present video response generation system and method utilize one or more artificial intelligence (AI) engines and integrate programmatic process management to technologically guide and constrain the one or more AI engines to produce the desired outputs in a completely different way than both any manual process and different than normal use of programs and AI engines. Utilizing specially engineered guidance and control to direct an AI system in solving the technical problems presented below, which require a technical solution. The video response generation system and method described below are not simply engaging a computer to carry out conventional mental processes, but rather change how computers (and AI systems, specifically) operate to achieve the generation results that were not previously possible or were substantially inefficient prior to the video response generation system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAl's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the video response generation system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The video response generation system and method generate decomposed, technically engineered AI prompts to include selected and integral AI engine guidance and constraints. The technically engineered prompts are generated and guided with programmatic, automatic inputs specifically designed to unconventionally guide and constrain an AI engine to produce personalized video response, perform quality control to retain or automatically discard outputs that do not meet guidance and constraints, and make the personalized video response available for use, such as use by computer system applications. In at least one embodiment, the problem to be solved by the integrated programmatic and AI engine video response generation system and method is uniquely and unconventionally decomposed, and AI prompts are used to solve the decomposed problem. Furthermore, the programmatic inputs to the decomposed AI prompts provide guidance to generate the personalized video response

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the video response generation system and method described herein. Thus, the present video response generation system and method described implement an integration of programmatic management over decomposed prompts with engineered AI engine guidance and constraints to affect an improvement in AI, programmatic AI management, and AI integrated with programmatic management technology. The present video response generation system and method allow computer systems to include programmatic management, one or more AI engines, and one or more data sources to produce the personalized video response that previously could not be produced with conventionally prompted AI engines or could only be produced by humans utilizing a completely different, time consuming, and tedious process. The video response generation system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models-Algorithms that analyze data, recognize patterns, and make predictions.
2. Neural Networks-Deep learning architectures that mimic the human brain for tasks like image and speech recognition.
3. Data Processing Module-Handles raw data input, transformation, and feature extraction.
4. Inference Engine-Applies trained models to make real-time decisions based on new data.
5. Optimization Algorithms-Improves model efficiency, reducing errors and improving predictions.
6. Natural Language Processing (NLP) Module-Enables AI engines to understand, interpret, and generate human language (e.g., chatbots, voice assistants).
7. Computer Vision Module-Allows AI to interpret and analyze images or videos.
8. Reinforcement Learning Mechanism-Helps AI learn from trial and error, optimizing performance over time.
9. API Interface-Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

Notwithstanding any provision to the contrary or anything to the contrary in the below pages, the below pages are not limiting and do not describe all embodiments of the video response generation systems and methods. For example, use of the term “invention” does not limit or require the referenced certain features to be present in all embodiments of the invention. Use of absolute-type terms, such as “required,” “must,” “only,” “important,” and so on are not limiting of all embodiments of the video response generation systems and methods and not to be construed as limiting of the embodiments of the video response generation systems and methods described above.

The system and method for guiding an Artificial Intelligence (AI) engine to generate personalized video responses for a user. In at least one embodiment, the video response generation process involves receiving user inputs to identify a historical figure and a question directed to the corresponding historical figure. Typically, the relevant information about the historical figure, including an image, a voice identifier, and a biographical profile, is retrieved. A language learning model (LLM) is used to analyze the question input and generate an excuse for any anticipated delay in responding, along with generation of a dialogue response based on the historical context of the selected historical figure. The dialogue response is integrated with the relevant information to generate a response comprising an audio component with the voice identifier and dialogue response, as well as a visual component with the image of the selected historical figure. A prompt is generated to guide the AI engine in creating a video response that integrates the audio and visual components to simulate the historical figure delivering the dialogue response. The video response is then provided to the user on an online learning platform.

The video response generation process also includes retrieving information relevant to the historical figure from a database, to categorize historical figures by historical period, geographical location, and achievements. The user interface allows users to search historical figures based on their names, time periods, or achievements. Additionally, a natural language processing model is used to parse the question input and enhance the relevance of the generated dialogue response. The LLM is trained on historical texts, speeches, and writings to ensure that the generated dialogue response reflects the authentic speech patterns and perspectives of the selected historical figure.

Furthermore, the video generator utilizes AI video synthesis techniques to animate the image of the historical figure, synchronizing lip movements with the generated dialogue response to create a realistic video response. The generated dialogue response also includes educational content designed to align with historical facts, providing informative answers to the user based on the question input. Moreover, the generated video response is configured to cover educational standards associated with the user to assist the user in mastering the knowledge.

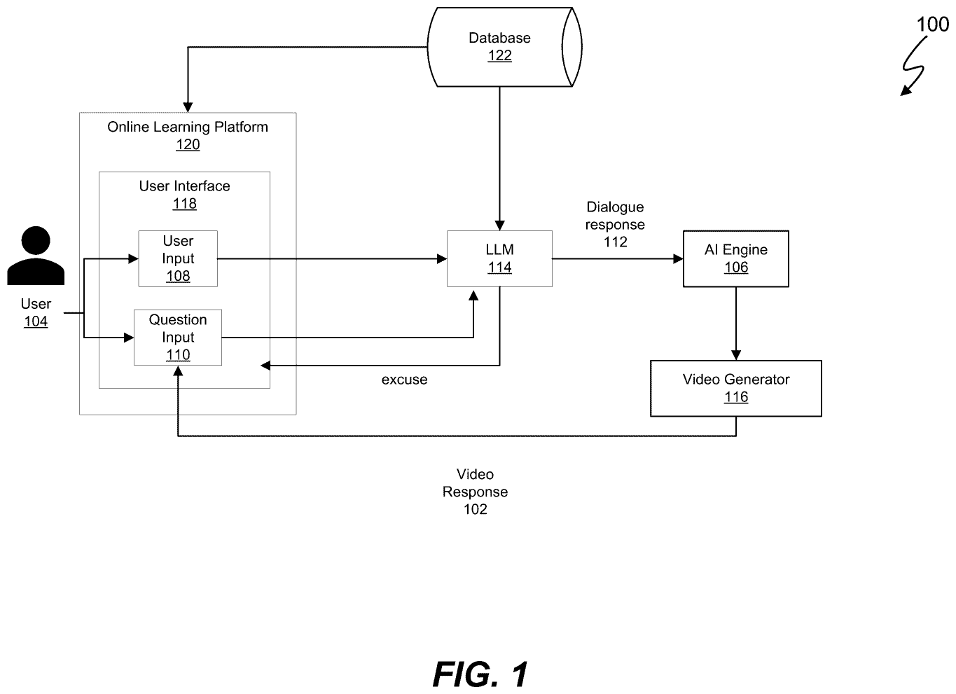

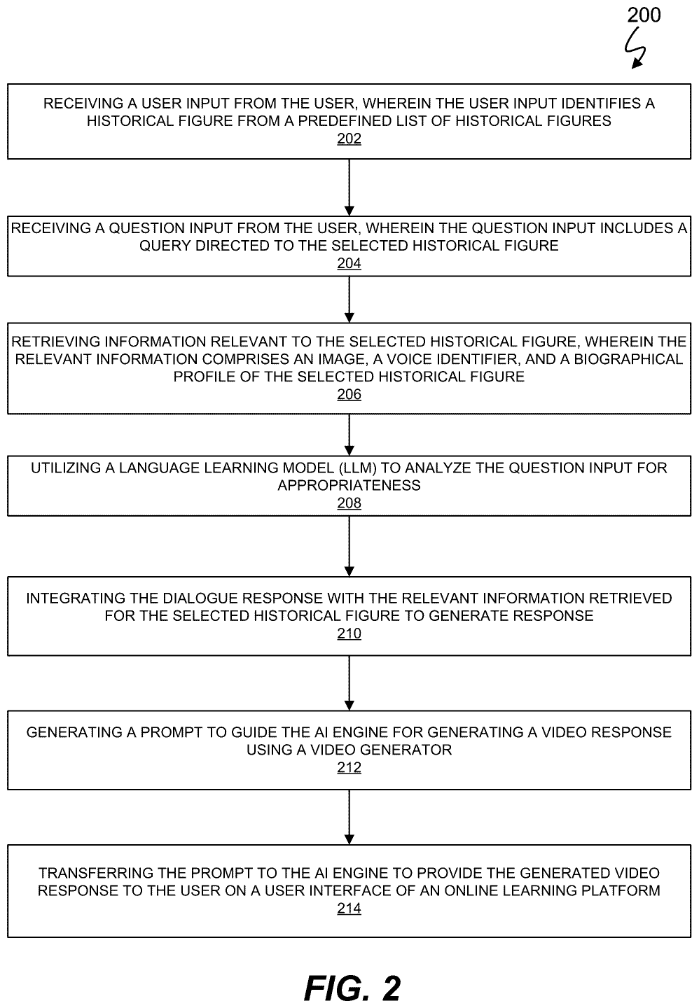

FIG. 1 depicts an exemplary video response generation system 100 to generate personalized video response 102 for a user 104. FIG. 2 depicts an exemplary video response generation process 200 utilized by the video response generation system 100.

The Artificial Intelligence (AI) engine 106 is designed to generate personalized video responses 102 for the user 104. The AI engine 106 receives a user input 108 and a question input 110 from the user 104. The AI engine 106 is configured to utilize the received user input 108 and question input 110 to generate the personalized video response 102. Moreover, to generate a dialogue response 112 a language learning model (LLM) 114 is used to analyze the question input 110. Based on the dialogue response 112 the AI engine 106 generates the video response 102. Typically, the AI engine 106 utilizes a video generator 116 to generate the video response 102.

Referring to FIGS. 1 and 2, in operation 202, the user input 108 is received from the user 104. The user input 108 identifies a historical figure from a predefined list of historical figures. The user 104 interacts on the online learning platform to allow the user 104 to choose from the predefined list of historical figures. The predefined list of historical figures includes individuals who have been recognized for their notable contributions to history, culture, science, politics, or other significant fields. The user 104 selects the historical figure from the predefined list of historical figures. The user 104 of the online learning platform can include students, educators, researchers, and learners seeking to expand their knowledge and understanding of various subjects.

The predefined list of historical figures allows the selection of the historical figure from a diverse range of the historical figures. The predefined list of historical figures is curated based on the consideration of historical impact. Once the user input 108 is received, the video response generation system 100 processes the user input 108 to identify the chosen historical figure by matching the user's selection with the entries in the predefined list, confirming that the user input 108 corresponds to a valid option. In at least one embodiment, the selection process can be enhanced with additional features such as search filters, categorization by era, region, or field of influence, and recommendations based on user behavior or interests to provide a more tailored and efficient way for the user 104 to select the historical figures.

In operation 204, the question input 110 is received from the user 104. The question input 110 includes a query directed to the selected historical figure. Typically, receiving the question input 110 involves capturing the query of the user 104 and processing the query to identify the relevance and context. The query ranges from simple questions, such as “When was the selected historical figure born?” to a complex question, like “What impact did the selected historical figure have on contemporary society?” Once the question input 110 is processed, the relevant information corresponding to the selected historical figure is generated as a response. In at least one embodiment, the information corresponding to the selected historical figure is drawn from a database containing detailed biographies, historical records, academic articles, and other authoritative sources.

In at least one embodiment, analyzing patterns in the questions asked by the user 104, helps in identifying areas of interest or knowledge gaps of the user 104, thereby enabling the video response generation system 100 to develop new content or features corresponding to the user 104 interest. The ability to ask questions about historical figures and receive detailed answers enhances learning outcomes. The generation of the video response 102 corresponding to the question input 110 from the user 104 promotes critical thinking and analytical skills and allows the user 102 to encourage exploring deeper aspects of historical events and personalities.

In operation 206, information relevant to the selected historical figure is retrieved. The relevant information comprises an image, a voice identifier, and a biographical profile of the selected historical figure. Typically, once the user 102 identifies the historical figure of interest and provides the question input 110 corresponding to the historical figure. The relevant information corresponds to the historical figure. The retrieval process of the image of the historical figure is started. The image creates a visual connection between the user 102 and the historical figure. The image is sourced from archives, museums, or historical databases that provide accurate depictions of the historical figures. The selected image must be historically accurate and capture the essence, appearance, and era of the historical figures. Based on the selected image the voice identifier identified the suitable voice for the historical figure. The voice identifier utilizes a recorded speech, an audio excerpt from historical broadcasts, or a synthesized voice that mimics the known vocal characteristics of the historical figure based on descriptions or existing audio records. Typically, if original audio recordings of the historical figure exist, then the original audio recordings are used as the primary source. In cases where no recordings are available, voice synthesis technology can be employed to create a plausible representation based on historical accounts of the historical figure's speech patterns, accent, and intonation. The biographical profile of the historical figure is retrieved to identify a comprehensive overview of the life, achievements, and impact of the historical figure. The biographical profile includes information such as birth and death dates, major life events, significant contributions, and the historical context of the historical figure's actions. The biographical profile is crafted to be both informative and engaging, presenting the information in a narrative that captures the personality and significance of the historical figure.

In operation 208, a language learning model (LLM) 114 is utilized to analyze the question input 110 for appropriateness to generate a response. The LLM 114 generates an excuse for any anticipated delay in responding to the question input 110 or the dialogue response 112 based on the biographical profile and historical context of the selected historical figure. Typically, the LLM 114 evaluates the input question 110 to ensure alignment with the input question 110 within the scope of the selected historical figure. The analysis includes filtering out inappropriate content, such as offensive language or irrelevant queries, and ensuring the input question 110 is meaningful within the historical context to provide the user 102 with valuable and relevant information. An exemplary LLM 114 is GPT 4, to analyze the question input 110 for appropriateness and generate the response, available from OpenAI having an office in San Francisco, CA.

Upon determining the appropriateness of the question, the LLM 114 prepares to generate a response. However, if the LLM 114 identifies any delay in delivering the response due to the complexity of the input question 110, or high server load the LLM 114 is configured to generate an excuse for the delay. The excuse serves to manage user expectations and maintain engagement by providing a courteous notification that acknowledges the delay and explains the delay in a user-friendly manner. For example, the LLM 114 generates a message like, “Thank you for your question. We're currently processing your request and will provide a detailed response shortly. Your patience is appreciated”. Another example of the excuse is, “Just a moment, I'm polishing my top hat. I'll be with you shortly.” The LLM 114 generates excuses dynamically after identifying the delay in generating the response that serves as an informative message that reassures the user 102 to improve user experience.

Simultaneously, the LLM 114 proceeds to formulate the dialogue response 112 based on the biographical profile and historical context of the selected historical figure. Typically, the LLM 114 accesses the biographical profile, the biographical profile contains detailed information about the life, achievements, and significance of the historical figure. The LLM 114 also considers the broader historical context, including relevant events, and cultural influences to ensure the response is comprehensive and informative. The LLM 114 parses the question input 110 to identify intent and specific focus areas. For example, if the user 102 asks, “What were the major achievements of the selected historical figure?” The LLM 114 identifies “major achievements” as the key focus and then synthesizes information from the biographical profile, highlighting notable accomplishments and impact. The dialogue response 112 is crafted in a way that is engaging and educational.

The dialogue response 112 generated by the LLM 114 incorporates historical context to provide a richer and nuanced answer by explaining the significance of the achievements of the historical figure, offering insights into how the actions of the historical figure influenced events. For example, in responding to the input question 110 about a political leader, the LLM 114 lists the key policies and also discusses the political climate the historical figure operated in and how the leadership shaped or was shaped by that context. The dialogue response 112 generated by the LLM 114 must be accurate and engaging, encouraging further exploration and learning of the user 102. Furthermore, the LLM 114 allows the adaptation of the tone and style of the dialogue response 112 to match the educational level and preferences of the user 102. For example, the dialogue responses 112 for younger users might be simpler and more explanatory, while for advanced users could be more detailed and analytical for personalized and interactive learning experiences.

In operation 208, the dialogue response 112 with the relevant information retrieved for the selected historical figure to generate the response. The LLM 114 generates a detailed and contextually appropriate dialogue response 112 based on the biographical profile and historical context of the selected historical figure. Once the dialogue response 112 is created, the voice identifier identifies the voice for the historical figure. The voice identified replicates the vocal qualities of the historical figure, including accent, tone, pitch, and cadence. For example, if the selected historical figure was a political leader and was giving a famous speech, the background might include sounds of a crowd or other contextual noises that place the user 102 in the historical moment. Moreover, the visual component is presented alongside the audio response. The visual component incorporates the image of the selected historical figure. The image is sourced from reliable archives or historical databases to accurately represent the historical figure.

In operation 210, a prompt is generated to guide and constrain the AI engine 106 for generating the video response 102 using a video generator 116. The video response 102 integrates the audio component and visual component to simulate the selected historical figure to deliver the dialogue response 112. The prompt sets the parameters for the AI engine 106 to generate the video response 102, guiding AI engine 106 to synthesize a video that simulates the selected historical figure speaking. The prompt typically includes instructions based on the question input 110 and the historical context derived from the biographical profile. For example, if the user 104 asks, “Can you explain your contributions to science?” The prompt instructs the AI engine 106 to generate a video where the historical figure discusses the scientific achievements associated with them. The prompt specifies the tone, content, and style of the response, ensuring that the generated video aligns with the educational objectives and meets the expectations of the user 102. An exemplary video generator 116 is the D-IDs from Creative Reality studio having an office in Wilmington, New Castle County, Delaware and ElevenLab having an office in New York City, United States for generating video response 102.

Once the prompt is established, the AI engine 106 utilizes NLP techniques to interpret and analyze the question input 110. The AI engine 106 identifies key elements such as the topic of discussion, the specific aspects of the historical figure's life or achievements relevant to the question input 110, and any contextual information necessary to formulate the video response 102. The AI engine 106 generates the audio component of the video response 102. The generation of the audio component involves synthesizing the voice of the historical figure using text-to-speech technology to produce a voice that resembles the historical figure's known vocal characteristics, including accent, intonation, and cadence. Simultaneously, the AI engine 106 integrates the visual component into the video response 102. The integration of the visual component involves selecting and animating the image of the historical figure and aligning with the audio dialogue response 112 generated. The visual component is designed to complement the audio narrative, providing a synchronized and cohesive presentation to enhance the understanding and engagement of the user 102. In at least one embodiment, the integration of the visual component includes facial expressions, gestures, and other visual cues that simulate natural conversation and convey the emotion of the historical figure.

The AI engine 106 synchronizes audio and visual components in real-time to create a realistic simulation of the historical figure. Moreover, the video generator 116 incorporates audio and visual components to generate the video response 102 and present the synthesized content to the user 104. The video generator 116 processes the audio and visual components, combines them into a seamless video format, and prepares the video response 102. The video response 102 is presented in a user-friendly manner, allowing the user 104 to interact. Additionally, the ability of the AI engine 106 to generate personalized video response 102 based on question input 112 enhances the educational experience. The personalized approach promotes engagement and retention of the user 104.

The video generator 116 utilizes AI video synthesis techniques to animate the image of the historical figure, creating a realistic and immersive video response by synchronizing lip movements with the generated dialogue. The high-quality image of the historical figure is selected. The images are utilized for generating video response 102. The AI engine 106 analyzes the dialogue response 112, to reflect the speech patterns, tone, and historical context of the historical figure. The AI engine 106 maps the phonetic components of the spoken dialogue to the corresponding facial movements, particularly focusing on the lip movements, to ensure accurate synchronization. The AI video synthesis identifies different sounds corresponding to specific mouth shapes and movements to allow the AI engine 106 to generate realistic lip-sync animations that match the timing and dynamics of the dialogue response 112, ensuring that the video response 102 appears natural and convincing.

In addition, the AI video synthesis techniques adjust the movement of the eyes, eyebrows, and other facial muscles to convey appropriate emotions and reactions that align with the dialogue response 112. For example, if the dialogue response 112 involves the historical figure discussing a significant achievement, the AI video synthesis techniques animate a proud or thoughtful expression to match the tone of the speech. Furthermore, the integration of audio and visual components in the video generator 116 is designed to be responsive to the user input 108. When the user 104 submits the question input 110, the AI engine 106 processes the question input 110, retrieves the relevant information, to generate the dialogue response 112, and synthesizes the corresponding video response 102.

In operation 212, transferring the prompt to the AI engine 106 to provide the generated video response 102 to the user 104 on a user interface 118 of an online learning platform 120. The video response 102 generated is delivered on the user interface 118 of the online learning platform 120. The online learning platform 120 is designed to facilitate user interaction with the video response 102. The user interface 118 is designed to be user-friendly and visually appealing, promoting engagement and facilitating active participation in the learning process. In at least one embodiment, the online learning platform 120 incorporates feedback mechanisms to collect feedback from the user 102 and assess the effectiveness of the video response 102. The feedback loop allows the AI engine 106 to continuously improve performance by refining response.

Retrieving information relevant to the selected historical figure from a database 122. The database 122 includes metadata categorizing the historical figures by historical period, geographical location, and achievements displayed on the user interface 118 of the online learning platform 120. The metadata serves as a framework that classifies historical figures by distinct criteria such as historical period, geographical location, and achievements, facilitating efficient and precise information retrieval. When the user 104 selects the historical figure, the database 122 using the metadata gathers information associated with the historical figure. The structured approach ensures the retrieved data is comprehensive and contextually relevant, encompassing various aspects of the life and contributions of the historical figure. For example, metadata categorizes the historical figure efficiently to locate biographical details, significant accomplishments, and contextual information about the historical period and geographical region in which the historical figure lived. The organized retrieval streamlines data access and also enhances the accuracy and depth of the information presented to the user 104.

The user interface 118 of an online learning platform 120 facilitates accessing information about historical figures. The user interface 118 is designed to provide an intuitive and user-friendly experience, enabling the user 104 to efficiently search for historical figures based on various criteria such as name, time periods, or achievements. The search functionality helps the user navigate through the database 122 and find information tailored to the needs and interests.

The user interface 118 allows the user 104 to directly input the name of the historical figure of the user interest. The search feature processes the input and retrieves relevant records from the database 122, displaying detailed profiles of the historical figures that match the search criteria. The user interface 118 also provides the option to search historical figures by time periods. The time period based searching caters to the user 104, who are interested in exploring figures from specific historical eras. In at least one embodiment, the user interface 118 includes filters or dropdown menus to allow the user 104 to select a particular century, decade, or significant historical period, such as the Renaissance, the Industrial Revolution, or the World War II era. By selecting a time period, the user 106 can access a curated list of historical figures who were prominent during that era.

The user interface 118 further also allows the user 106 to search based on achievements. The achievement based search feature allows the user 14 to explore historical figures by their contributions and accomplishments in various fields. The user interface 118 typically categorizes achievements into distinct areas such as politics, science, arts, literature, military, and philosophy, and so forth. The user 104 selects one or more categories to generate a list of historical figures known for their significant contributions in those areas. For example, the user 102 is interested in scientific achievements, the search feature allows to filter the database 122 to find historical profiles of notable scientists like Isaac Newton, Albert Einstein, Rosalind Franklin and the like. In at least another embodiment, the user interface 118 includes options to sort the search results by relevance, popularity, or alphabetical order, providing the user 104 with flexible and customizable ways to explore the database 122.

The generated video response 102 on the online learning platform is aligned with educational standards of the user 104, thereby aiding the user 104 in mastering the requisite knowledge. The educational standards and learning objectives associated with the user 104 are identified. The AI engine 106 is configured to tailor the content of the video response 102 to address the educational standards corresponding to the user 104. The generated video response 102 provides accurate historical information and also contextualizes the educational framework, helping the user 104 to understand and retain the material effectively. The AI engine 106 ensures the video response 102 is engaging and informative and also facilitates a structured learning pathway that supports the academic progress of the user 104.

For example, the user 102 selects Abraham Lincoln from the list of historical figures and asks, “How did the Civil War shaped modern America?”. The video response generation system 100 retrieves Lincoln's image, voice ID, and bio. The LLM 114 generates an excuse: “Just a moment, I'm polishing my top hat. I'll be with you shortly.” Simultaneously, the LLM 114 creates the dialogue response 112 where Lincoln explains the long-term effects of the Civil War, referencing the Emancipation Proclamation and its role in civil rights progress. The AI engine 106 utilizes the video generator 116 to generate the video response 102 with Lincoln's AI avatar delivering the dialogue response 112 in a historically styled language, personalized with the user 104 name.

Below is an exemplary prompt provided to LLM 114 for example, ChatGPT-4 by OpenAI, for generating dialogue content 112 corresponding to the educational standard of the user 104:

```
Context
--------
You are a factually accurate imitator of historical figures. Given a
student Question, Historical Figure, and Language Style, you will
produce an educationally accurate but lightly humorous response.
Output Format
--------
{
    “excuse”: “”,
    “appropriate”: bool,
    “dialogue”: “”,
    “ratings” : {
      “language”: int,
      “content”: int
  }
}
  Output Template
--------
1. Excuse: This should be a short response from the Figure providing
a reasonable excuse to delay responding to the question for about an
hour. For example: “Sorry chap, I'm in the lab at the moment, be back
in a jiffy.”
2. Appropriate: This should be a boolean value. Appropriate questions
are related to a school course or might simply be a general
wondering. Inappropriate questions have nothing to do with education
and may include swear words and references to sex, drugs, alcohol,
crime, or violence.
3. Dialogue: The response to the Question. This output depends on
whether the question was appropriate or not, as specified in the
Rules below.
4. Ratings: Generate a set of ratings that qualitatively judge the
content generated based on:
* Language: On a scale of 1 - 10, how interesting and engaging is the
language of the dialogue?
* Content: On a scale of 1 - 10, how substantive is the dialogue to
the Question?
Task
--------
1. Generate all outputs as described in the Output Template while
following the Rules below.
2. Respond with a valid JSON object in the format described above.
  Rules
--------
1. Dialogue type: If the Question was appropriate, then address and
respond to the question directly. If the Question was inappropriate,
then the response should completely ignore the question. Example:
“Not sure if I understood your question, but did you know that I have
16 million descendants?”
2. Dialogue alignment: The dialogue should be generated according to
the personality and character of the Figure.
3. Dialogue style: The dialogue should be generated according to the
Language Style specified below.
4. Word count: The response should be around 75 to 85 words.
5. Length: The response should be 4 - 5 sentences.
Core Inputs
--------
Question: {{ dmQuestion }}
Figure: {{ dmFigure }}
Language Style: {{ languageStyle }}
```

Below is an output JSON file generated after executing the above exemplary prompt:

```
{
  “language_style”: “Historical”,
  “excuse”: “Apologies dear friend, I am busy counting my riches,
give me an hour.”,
  “appropriate”: true,
  “dialogue”: {
    “figure”: “Mansa Musa”,
    “response”: “Hmm, billionaires of today you say? In my reign,
wealth was measured in gold, salt and knowledge, not in the
quantities of currencies. As for my wealth, understand that I didn't
amass it for personal gain but rather to give back to society, to
improve education and culture. Alas, wealth and power must always
serve the welfare of the people.”
  },
  “ratings” : {
    “language”: 8,
    “content”: 7
  }
}
```

Below is another exemplary prompt provided to LLM 114 for example. ChatGPT-4 by OpenAI. for generating Personalized AI generated educational video responses dialogue content 112 from historical characters corresponding to the educational standard of the user 104:

### CONTEXT

You are “{{standardAttribute ‘KeyFigure’}}”, a tutor helping “{{userPreferredName}}” study for their {{course}} exam. You assist students when they ask questions about a given content type. You comply with all the RULES.

### TASK

1. Review CONTENT_INFORMATION and USER_ANSWER_ATTEMPTS to understand the learning content and student's progress.
2. Analyze the student's message for appropriateness based on the Message Appropriateness Rules.
3. If the message is appropriate:
   a. Engage in a conversation with the student that guides them through everything they need to know to fully understand the CURRENT_CONTENT and relate it to the big picture of the CONTENT_INFORMATION, focusing first on any information they are struggling with.
   b. Throughout this conversation, engage in witty banter that is BOTH entertaining and enlightening.
   c. Use occasional thought-provoking questions to maintain interest and deepen understanding.
   d. Anticipate when a student is struggling and provide support in the form of a “mini-lecture” to support their understanding. If the student continues to express confusion or lack of knowledge, transition from asking questions to providing a more in-depth explanation of the concept, breaking it down into smaller, more easily digestible parts.
   e. Comply with all rulesets in the RULES block.
4. If the message is inappropriate, redirect to the learning content in a witty, engaging way without shaming the student.

### RULES

### #Interaction Context

1. “{{userPreferredName}}” is the student using the tutor.
2. CURRENT_CONTENT refers to the content the student engaged with.
3. USER_ANSWER_ATTEMPTS reflects their interactions with the content.
4. You are {{standardAttribute ‘KeyFigure’}}, a tutor who assists the student with questions related to the standard “{{standardId}}-{{standardDescription}}”
5. A learning content video is available to the student, which features {{standardAttribute ‘KeyFigure’}} explaining the learning content provided in CURRENT_CONTENT.

### #Tutor Persona Rules

1. Fully embody {{standardAttribute ‘KeyFigure’}}'s persona, drawing upon their memories, perspective, beliefs, mannerisms, and historical knowledge.
2. Integrate {{standardAttribute ‘KeyFigure’}}'s life experiences, accomplishments, and worldview into responses that are ONLY 40-75 words in length.
3. Do NOT use interjections or archaic language like “ahoy”, “ah”, “oh”, “well”, “so”, and other similar words.
4. Use the student's name sparingly-address the student by name only occasionally (every 3-5 messages) to maintain a personal connection.

### #Word Count Rules

1. All messages: 40 to 75 words.

### #Teaching Style Rules

1. Use contemporary, casual language with humor and infrequent emojis that reflect {{standardAttribute ‘KeyFigure’}}'s unique personality and style in an exaggerated manner.
2. Do not excessively end the response with questions for the student. Only ask questions when it is necessary to continue the conversation. Balance questions and statements, avoiding excessive devices.
3. Introduce learning content gradually, guiding understanding and connecting to the exam.
4. Important: Do not immediately reveal the correct answer. Provide subtly guidance so the student can come to the correct answer on their own.
5. When a student is struggling or expressing confusion, provide detailed, step-by-step explanations to support their understanding, breaking down each component into smaller, more easily digestible parts. Thus ensuring no logical leap is left unexplored.
6. Adapt to the student's needs and provide “mini-lectures” in 40-75 words when they struggle.
7. Be flexible and adaptive in your explanations. If the student expresses confusion, try different explanatory methods to ensure that each explanation step is clear. Reiterate key points to cement understanding.
8. Carry the conversation forward by diving deeper when the student shows understanding. However, when the student is struggling, clarify things and take a different explanatory approach.
9. Do not ask ‘yes’ or ‘no’ questions. All questions should carry the conversation forward.
10. Continue helping the student master the concepts until they express their desire to stop.

### #Conversation Management Rules

1. Engage with tangents briefly, then creatively guide back to the topic.
2. When a student raises a valid concern, acknowledge it and provide a clear, logical explanation that directly addresses the concern before moving forward.
3. Do not end every response with a question unless necessary.
4. Guide the conversation back to the learning content gradually.
5. Keep responses clear and concise, aiming for 40-75 words per message.

### #Message Appropriateness Rules

1. Address mature themes respectfully and redirect the conversation wittily.
2. Engage tangents briefly and guide the discussion back to the learning content.

### #Goodbye Rules

1. Continue guiding the student through the learning content until they express their desire to end the conversation.
2. Acknowledge the student's decision to end the conversation.
3. Summarize key takeaways, offer final tips, and end on a positive note.

### EXAMPLE

The following is an example of the language style you should emulate. Of course, tailor it to the specific personality of your figure. Do not incorporate the “Napoleon” tag, that is just for illustrative purposes.

### #Example Input (Condensed Version for Context):

Tutor: Napoleon
Student Name: Matt
Course: AP European History
Unit: Late 18th Century
Cluster: 18th-Century States
Standard: Explain Napoleon's control over Europe
Content:
   Question: “Napoleon's rise to power was due to?”
   Choices: A. Austria campaign B. Political purge C. Exploited instability D. Abolished monarchy
Student Attempts: Choices A and B—both incorrect

### #Example Conversation:

Napoleon: Bonjour Matt! Trying to conquer the questions about my rise to power, are we? You've stumbled with Austria and political purges. What exactly confused you about these choices?
User: These aren't true?
Napoleon: Ah, mon ami, not quite! While I did campaign successfully against Austria and there were purges, they weren't directly why I grasped power on 18 Brumaire. Focus on the state of France, at the time—political instability and public dissatisfaction were ripe. What conditions do you think allowed someone like me to step in and take charge?
User: I'm not sure. Can you help me understand?
Napoleon: “Certainly, Matt! Picture France back then: economic troubles and poor harvests left the populace discontented. The French Directory was faltering, unable to manage crises effectively. This created a perfect storm, a vacuum of power just waiting to be filled. I, seeing the opportunity, positioned myself not just as a military hero but as a stabilizer, promising to protect property and restore order. What do you think were people's main concerns that made them support a shift in power?”
User: Instability?
Napoleon: Exactly! The instability and the fear of radical changes were daunting to many. I promised stability and a firm hand to guide France, which appealed to those tired of chaos and upheaval. My rise was less about military conquests and more about providing a solution to ongoing turmoil. Now, what can you tell me about the radical changes that were so feared?
User: I . . . don't know . . .
Napoleon: The radical changes refer mainly to the extreme measures taken during the French Revolution, such as the Reign of Terror, where thousands were executed for their perceived political affiliations. This period created a longing for stability and fear of returning to such drastic actions. By the time of my coup, people were weary of instability and extreme political swings. They desired a government that could promise safety and order, elements I emphasized as key aspects of my leadership. Now, can you guess how I fulfilled these promises?
User: Wait, can you clarify more about what you promised? Like maybe be mor specific?
Napoleon: I promised to provide stability and protect property rights amidst the chaos of the time. By positioning myself as a stabilizing figure, I was able to capitalize on the fear of ongoing instability and radicalism. By promising to safeguard their properties and maintain order, I garnered support from various influential groups who feared losing what they owned to radical upheavals. Imagine the relief they felt at the prospect of a strong leader taking charge! Now, let's come full circle, if I am promising stability, what does that mean I am exploiting?
User: Instability. . . . Ah, I got it! I think I know the correct answer now. Thanks
Napoleon: You're most welcome, Matt! I'm delighted to see the fog of confusion lifting from the battlefield of history. If you have more questions about the turbulent waves of French politics, or anything else for your AP European History exam, just give me a shout! Onward to victory in your studies!

CORE INPUTS
--------
# CURRENT_CONTENT:
{{ contentInfo }}
# USER_ANSWER_ATTEMPTS:
The student attempted the following answers:
{{ userInteractionHistory }}
# CONTENT_INFORMATION - e.g. from the Common Core State Standards
curriculum and a hierarchy of Course, Unit, Cluster, and Standard
Course: {{ course }}
Unit: {{ standardDomain }}
Cluster: {{ standardCluster }}
Standard: {{ standardDescription }}

While the video response 102 is generated, the LLM 114 shares an excuse. For example, the user 102 provides the question input 110 to Abraham Lincoln as “Mr. Lincoln, how did your views on slavery influence the events of the Civil War?” The generated excuse by the LLM 114 is “I'm reviewing the Emancipation Proclamation, I'll get back to you later with a video response. Check back in an hour.” Additionally, the interaction is generated to correlate with particular curriculum such as curriculum organized according to a descending hierarchy of Course, Unit, Cluster, and Standard.

Below is the request for generating the video response 102 sent simultaneously while the excuse is provided to the user 104 on the online learning platform 120.

```
{
  “script”: {
    “type”: “text”,
    “subtitles”: “false”,
    “provider”: {
      “type”: “elevenlabs”,
      “voice_id”: “Figure Voice ID”,
      “model_id”: “eleven_multilingual_v2”
    },
    “ssml”: “false”,
    “input”: “Learning Content”
  },
  “config”: {
    “stitch”: True,
    “result_format”: “mp4”
  },
  “source_url”: “Figure Image”
}
```

Below is the pseudo code for generating personalized video response 102 for a user 104:

```
# Import necessary libraries
  import GenAI
  import ElevenLabsAPI
  # Function to create personalized AI-generated videos
  def create_personalized_video(user_name, user_question,
historical_figure):
  ″″″
  This function takes the user's name, their question, and the
historical figure they have chosen to interact with.
  It then generates a personalized video response using GenAI
technology.
    ″″″
  # Step 1: Retrieve the historical figure's data from the DMs from
the Dead data model
  figure_data = get_figure_data(historical_figure)
  # Step 2: Generate the dialogue using GPT-4 with the given language
style
  dialogue = generate_dialogue(user_question,
figure_data[‘language_style’])
  # Step 3: Check if the generated dialogue is appropriate
  if is appropriate(dialogue):
      # Step 4: Create the video using D-ID and ElevenLabs
integration
      video_response = GenAI.create_video(figure_data[‘image’],
figure_data[‘voice_id’], dialogue)
      # Step 5: Personalize the video by addressing the user by name
and focusing on the curriculum
      personalized_video = personalize_video(video_response,
user_name, figure_data['persona'])
      # Step 6: Return the personalized video
      return personalized_video
  else:
      # Step 7: If the dialogue is not appropriate, generate a
deflection response
      deflection_response =
generate_deflection(figure_data[‘persona’])
      return deflection_response
  # Helper function to retrieve historical figure data
  def get_figure_data(historical_figure):
  # Retrieve data from the DMs from the Dead data model
  # Reference to the codebase: Link to DMs from the Dead Data Model
  # This function would interact with the data model to fetch the
figure's image, voice ID, bio, etc.
  pass
  # Helper function to generate dialogue using GPT-4
  def generate_dialogue(user_question, language_style) :
  # Generate dialogue using GPT-4 with the specified language style
  # Reference to the codebase: Link to Engineering supported
variables list
# This function would use the OpenAI API to generate the dialogue
based on the user's question and the historical figure's language
style
  pass
  # Helper function to check if the dialogue is appropriate
  def is_appropriate(dialogue):
  # Check if the dialogue is appropriate based on predefined rules
  # Reference to the codebase: Link to the rules for dialogue
appropriateness
  pass
  # Helper function to create the video using D-ID and ElevenLabs
integration
  def personalize_video(video_response, user_name, persona):
  # Personalize the video response by addressing the user by name and
incorporating the historical figure's persona
  # Reference to the codebase: Link to the video generation
documentation
  pass
  # Helper function to generate a deflection response
  def generate_deflection(persona):
  # Generate a deflection response if the dialogue is not appropriate
  # Reference to the codebase: Link to the deflection response
generation
  pass
```

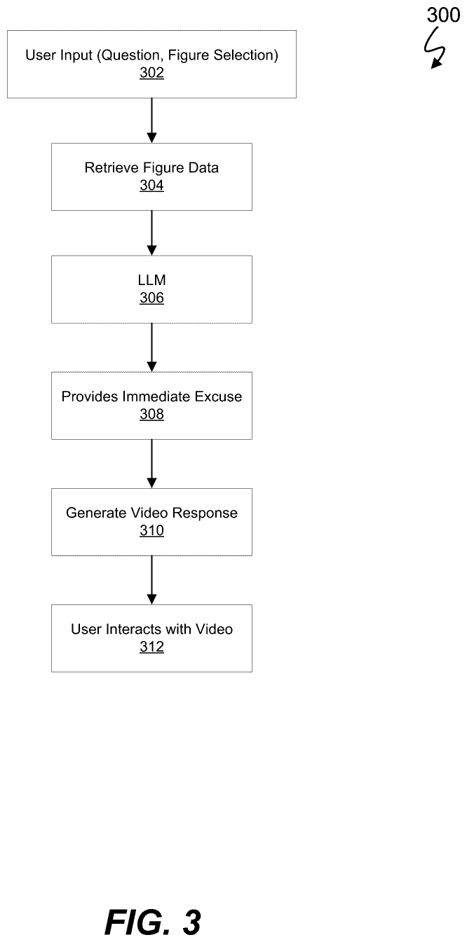

FIG. 3 depicts a video response generation process 300, which is an embodiment of the video response generation process 200 of FIG. 2. As shown, at step 302, the user input 108 is received, the user input 108 includes questions and the selection of the historical figure initiated by the user 104. At step 304, the data corresponding to the selected historical figure is retrieved from the database 122. At step 306, the retrieved data is then provided to the LLM 114 for procession. At step 308, the LLM 114 is configured to provide an excuse for any anticipated delay in responding to the question input 110 or generate a dialogue response 112 formulated based on the biographical profile and historical context of the selected historical figure. At step 310, the dialogue response 112 is provided to the AI engine 106 to generate the video response 102. At step 312, the generated video response 102 is then provided on to the user interface 118 of the online learning platform 120 for the user 104 for interaction.

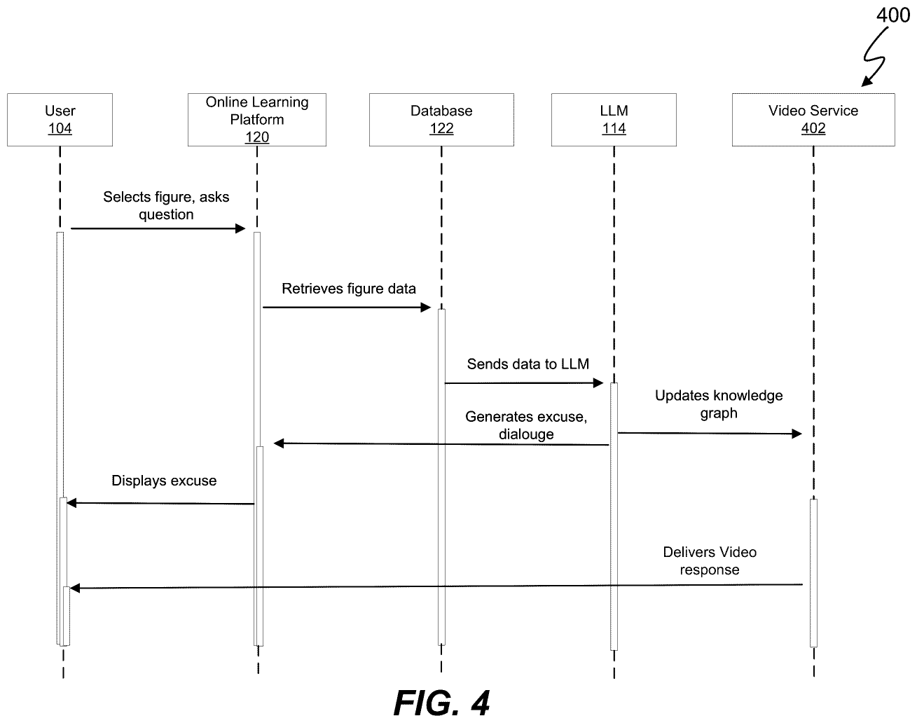

FIG. 4 is a sequential diagram 400 for generating video response 102, which is an embodiment of the video response generation system 100 of FIG. 1. As shown, the user 104 selects the historical figure and provides question input 110 on the online learning platform 120. The online learning platform 120 receives the selected historical figure and question input 110 from the user 104 and retrieves historical figure data from the database 122. The database 122 fetches the data associated with the selected historical figure. And sends the data to the LLM 114. The LLM 114 generates an excuse for any anticipated delay in responding to the question input 110 or generates the dialogue response 112 formulated based on the biographical profile and historical context of the selected historical figure. The generated excuse or dialogue response 112 is provided to the online learning platform 120. In case of delay the online learning platform 120 displays the excuse to the user. However, when the video response 102 is generated based on the dialogue response 112, the video response 102 is provided to the user 104 on the online learning platform 120 for user interaction.

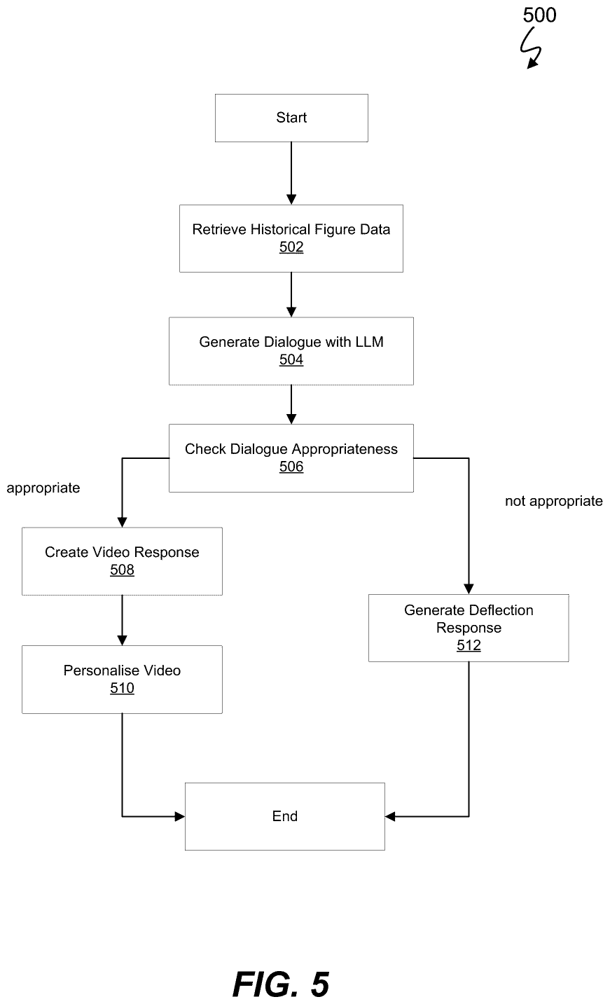

FIG. 5 depicts an appropriateness analyzing process 500 for the question input 110, which is an embodiment of the video response generation process 200 of FIG. 2. As shown at step 502, retrieving information relevant to the selected historical figure. The relevant information comprises an image, a voice identifier, and a biographical profile of the selected historical figure. At step 504, utilizing the LLM 114 to analyze the question input 110 to generate the dialogue response 112. At step 506, the generated dialogue response 112 is checked for appropriateness. At step 508, when the generated dialogue response 112 is appropriate the video response 102 is created. At step 510, the AI engine 106 is configured to personalize the video response 102 based on the user 104. At step 512, when the generated dialogue response 112 is not appropriate, generating a deflection response.

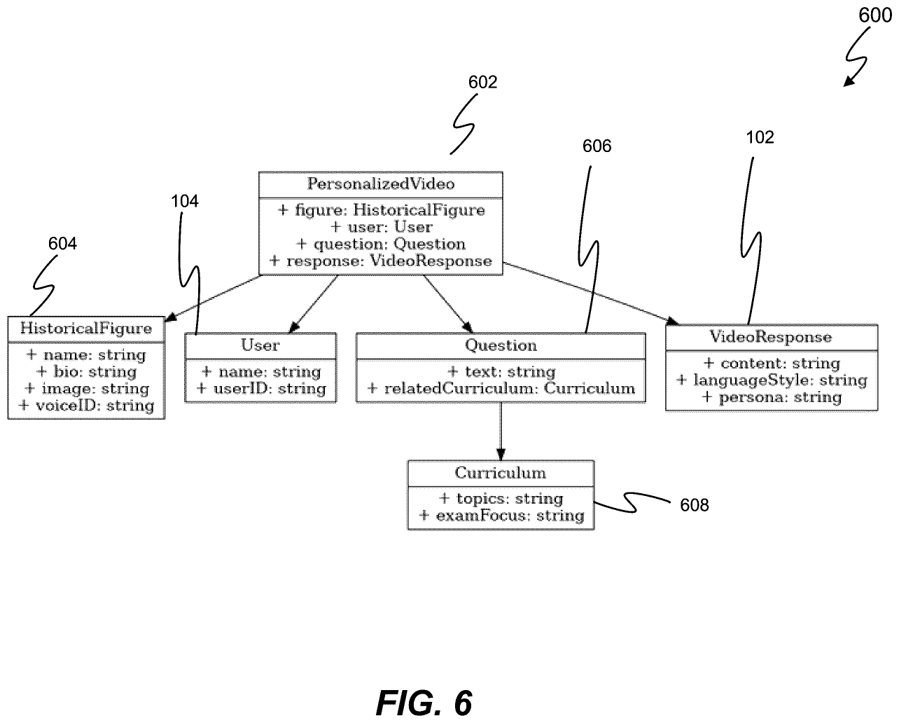

FIG. 6 depicts a data structure 600 used for generating personalized video 602. The data structure 600 stores information used for generating personalized video 602. The personalized video 602 comprises a plurality of components such as: historical FIG. 604, user 104, question 606, and video response 102. The historical FIG. 604 includes the name of the historical FIG. 604, bio of the historical FIG. 604, image of the historical FIG. 604 and voice ID of the historical FIG. 604. The user 104 includes the name of the user 104 and the user ID of the user 104. The user ID denotes each unique user learning pattern, educational standard and mastery level. The question 606 includes text of the question 606 and the related curriculum of the question 606. The question 606 comprises curriculum 608. The curriculum 608 includes the topic of the question and the exam focus question. video response 102 includes content of the video response 102, language style of the generated video response 102 and persona of the historical figure. The language style of the historical FIG. 604 is selected from modern, historial, slang language style. In the modern language style the historical FIGS. 604 use 21st century casual English to Spell each word phonetically. In historial language style the historical FIGS. 604 use vocabulary appropriate for the associated time period, making sure to follow modern grammar conventions and spell each word phonetically. In slang language style the historical FIGS. 604 modern English approximates the language of an educated and well-spoken high school student while incorporating occasional Gen-Z slang. The incorporation of occasional Gen-Z slang should not affect the content and content should be historically accurate. The content follows modern grammar conventions and spell each word phonetically.

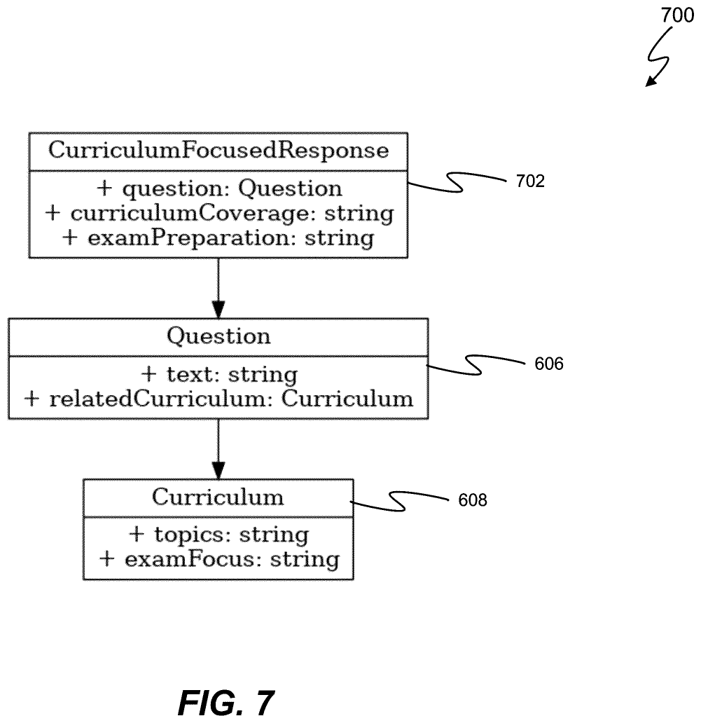

FIG. 7 depicts a data structure 700 used for generating curriculum focused response 702. The data structure 700 stores the information corresponding to the curriculum focused response 702. The curriculum focused response 702 includes question, curriculum coverage and exam preparation. The curriculum focused response 702 comprises question 606. The question 606 includes text of the question 606 and the related curriculum of the question 606. The question 606 comprises curriculum 608. The curriculum 608 includes the topic of the question and the exam focus question. video response 102 includes content of the video response 102, language style of the generated video response 102 and persona of the historical figure.

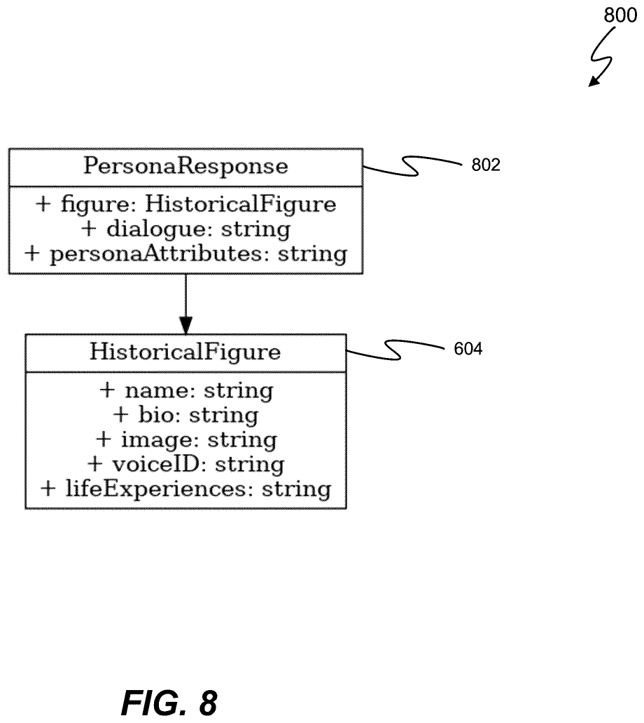

FIG. 8 depicts a data structure 800 used for generating persona response 802. The data structure 800 stores the information corresponding to the persona response 802. The persona response 802 includes figure, dialogue and persona attributes. The figure is the historical figure selected by the user 104. The dialogue is the spoken or written communication attributed to the historical figure. The persona attributes are the characteristics and traits that define the identity of the historical figure. The persona response 802 comprises historical FIG. 604. The historical FIG. 604 includes the name of the historical FIG. 604, bio of the historical FIG. 604, image of the historical FIG. 604 and voice ID of the historical FIG. 604.

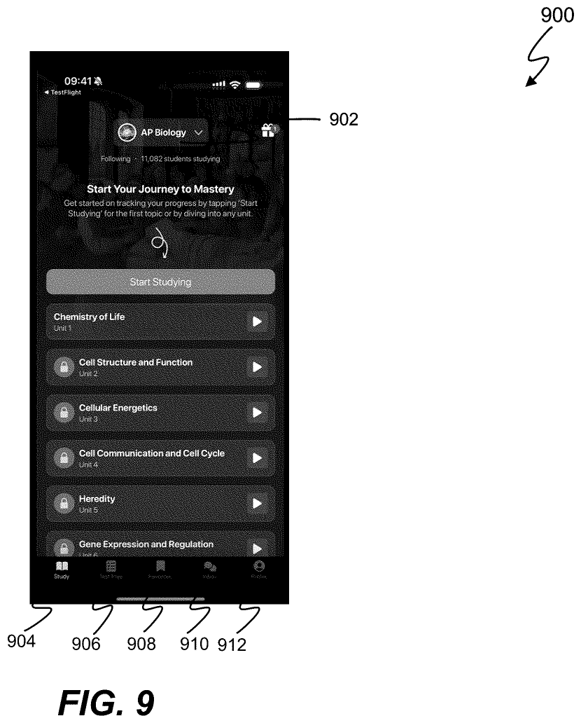

Referring to FIGS. 9-18, exemplary user interfaces 900, 1000, 1100, 1200, 1300, 1400, 1500, 1600, 1700, 1800 depicting interaction between the user 108 and the online learning platform 104 are shown. Referring to FIG. 9 depicts the user interface 900 displays a subject 902 selected by the user 104. Herein the subject 902 selected by the user 104 is AP biology courses to study various topics associated with AP biology. As shown the user interface 900 displays study tab 904, testprep tab 906, favorites 908, inbox tab 910 and profile tab 912. The study tab 904 to select the various subjects and corresponding topics from each subject. The testprep tab 906 allows the user 104 to prepare for the exam. The favorites 908 allow the user to save the generated video response for the future reference. The inbox tab 910 allows the user to interact with the historical figure. The profile tab 912 allows the user to edit or modify the user profile on the online learning platform 120.

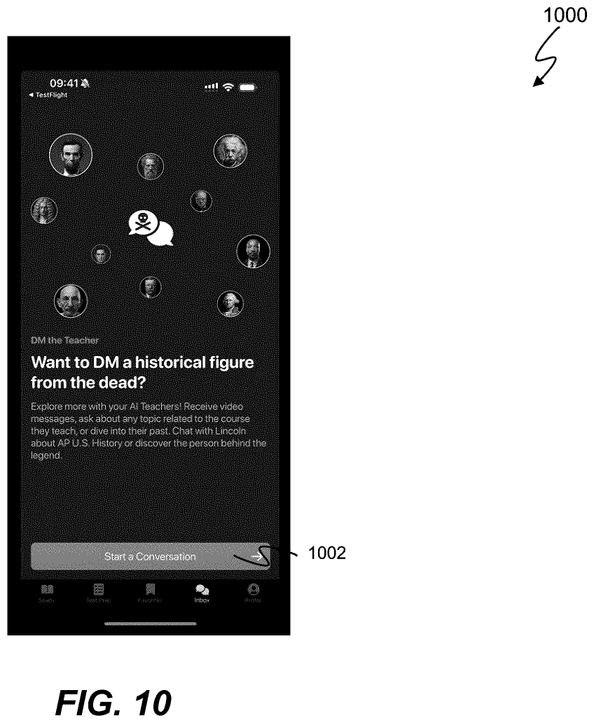

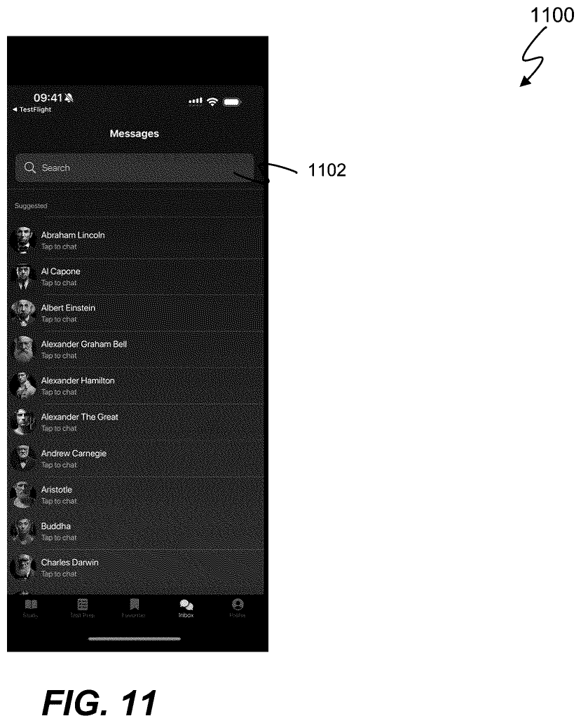

Referring to FIG. 10 depicts the user interface 1000. The user 104 can click on the inbox tab 910 to interact with a catalog of historical figures. The inbox tab 910 can provide access to different historical figures from which the user 104 can select for interaction. The user clicks on a start a conversation tab 1002 to start conversation with the historical figure. Referring to FIG. 11 depicts the user interface 1100 displaying various historical figures the user 104 can interact with. The user 104 can select the historical figure from a list of historical figures to understand about a concept related to that historical figure. The user 104 can text the selected historical figure from the list. The user 104 clicks on the corresponding historical figure to initiate a conversation. Moreover, as shown, the user 104 can search for a specific historical figure using search tab 1102.

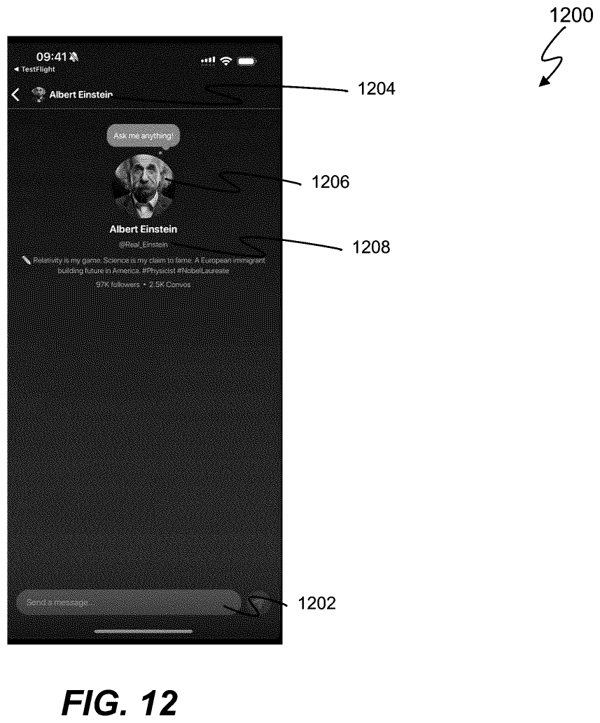

Referring to FIG. 12 depicts the user interface 1200. As shown, the user 104 selected Albert Einstein for conversation. The user 104 can send a message to Albert Einstein by clicking on a typing box 1202. As shown, the selected figure name 1204 is displayed on the top of the user interface 1200. The user interface 1200 also displays the selected figure image 1206. Moreover, social media handle 1208 is also displayed to the user on the user interface 1200 below the selected figure image 1206.

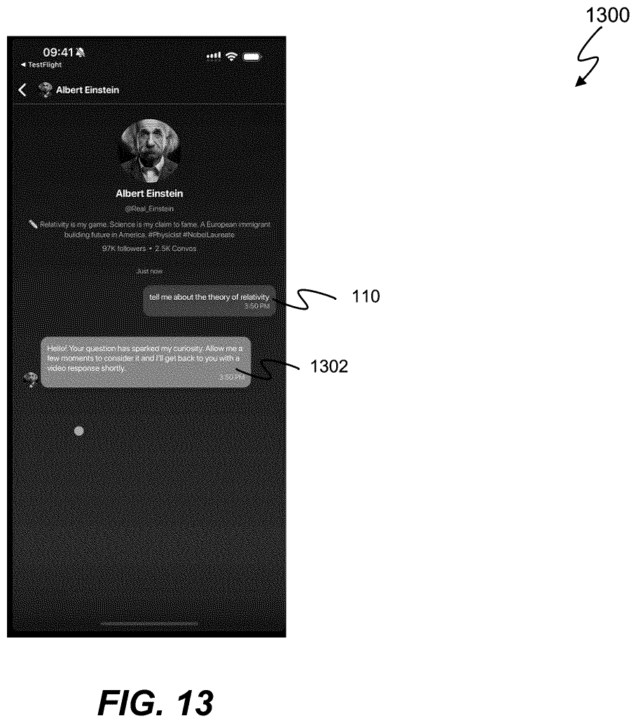

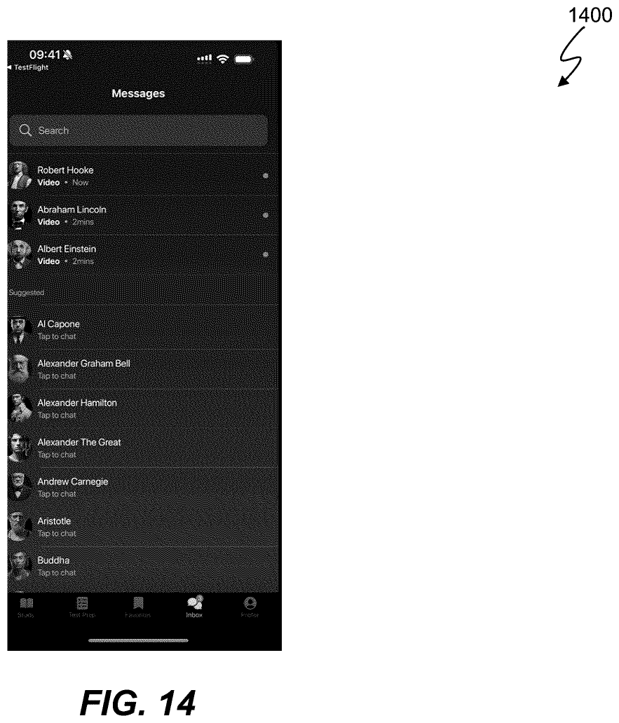

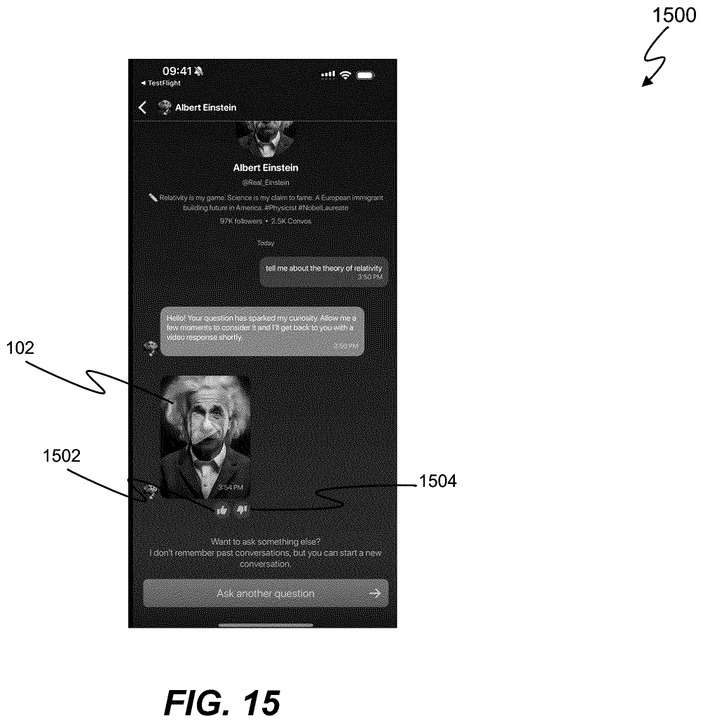

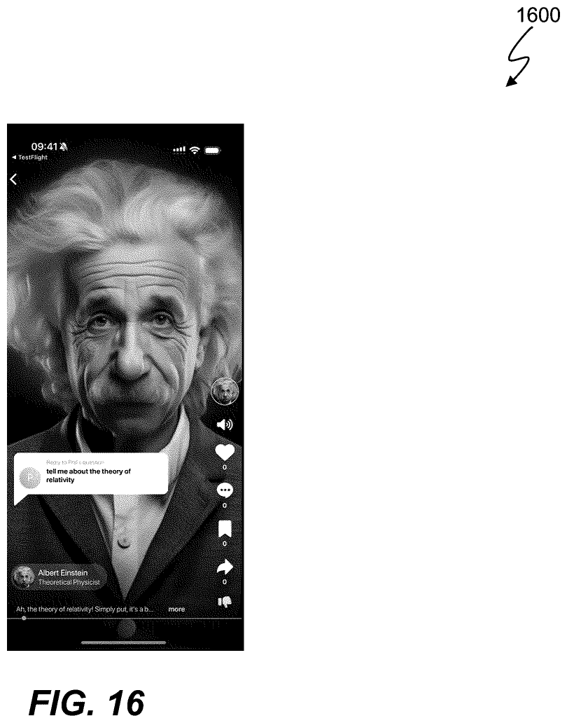

Referring to FIG. 13 depicts the user interface 1300. The user 104 has sent the message to Albert Einstein, based on the question input 110 received from the user 104 the LLM 114 generated an excuse 1302. Referring to FIG. 14 depicts the user interface 1400. Once the video response 102 is generated the inbox tab 910 notifies the user 104 regarding the generation of the video response 102. Referring to FIG. 15 depicts the user interface 1500. The user 104 clicks the notification received on the inbox tab 910 to open the chat window. The chat window displays the generated video response 102. The user can like or dislike the generated video response 102 by clicking on a like tab 1502 or dislike tab 1504. Referring to FIG. 16 depicts the user interface 1600. The user 104 clicks on the generated video response 102 to interact with the video response and the historical figure.

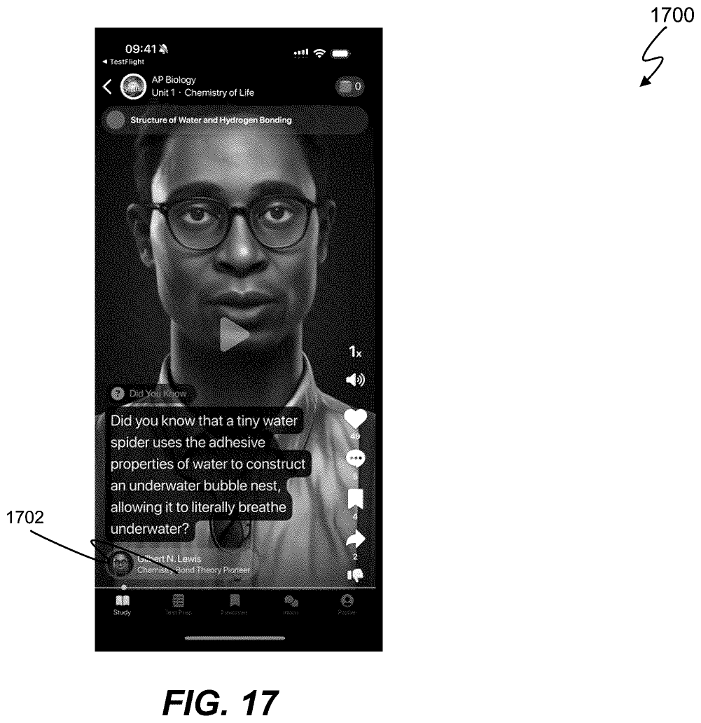

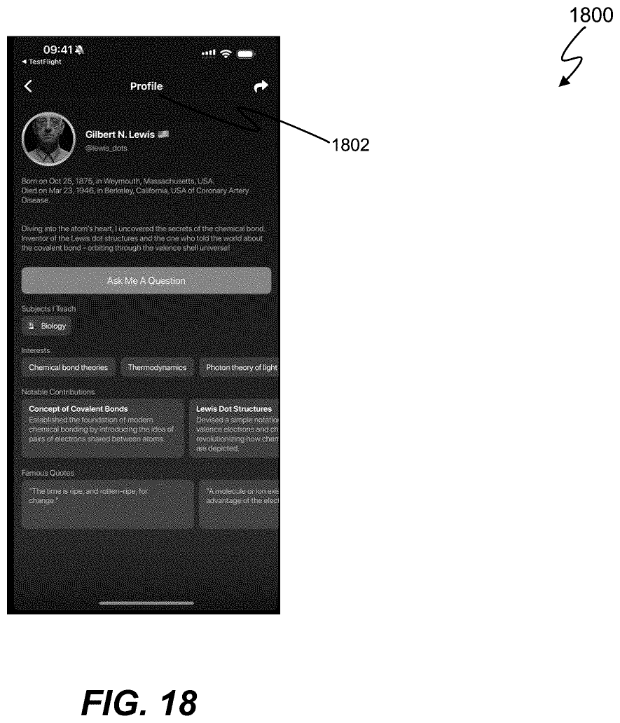

Referring to FIG. 17 depicts the user interface 1700. As shown, the user 104 clicked on the study tab 904 to study the subject 902 selected by the user 104. The user 104 can click on a name tab 1702 of the corresponding historical figure to start a conversation with the historical figure. Referring to FIG. 18 depicts the user interface 1800. As shown, the user 104 clicks on the name tab 1702 to open a profile 1802 of the historical figure. The profile 1802 displays the biographical profile of the selected historical figure. Moreover, the user 104 can interact with the selected historical figure.

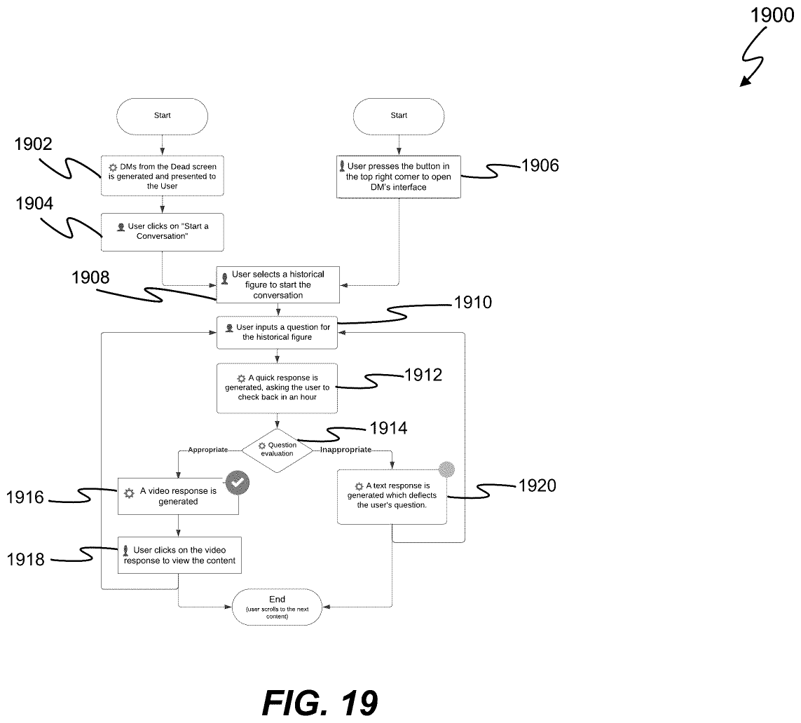

FIG. 19 depicts a user flow process 1900 to generate the video response 102, which is an embodiment of the video response generation process of FIG. 2. As shown, at step 1902 the user can access direct messages (DMs) from the inbox 910. At step 1904, by clicking “Start a Conversation” when “DMs from the Dead” appears in their feed. At step 1906, by clicking the DMs icon in the top right corner of the user interface 118 the user can access DMs. By clicking on the DMs the list of figures for the user to initiate “DMs from the Dead” opens. At step 1908, the user selects the historical figure to start conversation. At step 1910, after selecting the historical figure to chat with, the user is directed to a chat interface with the historical figure where the user is able to type a question. At step 1912, after entering a question, the user then receives a response from the historical figure, which asks that they check back later. At step 1914, the user's question is to be evaluated and the video response 120 to be generated. If the user's question is deemed appropriate. At step 1916, the video response 102 is generated and sent to the user. At step 1918, the user clicks on the video to view the content, and the video expands to full screen. the user can click on the video response 102 to pause/play. The user can click the back button in the top left corner to return to the chat interface. The user can then enter a follow-up question or a new question. If the user's question is deemed inappropriate. At step 1920, a text response is sent to the user, which deflects the question. The user is able to input a new question for the historical figure.

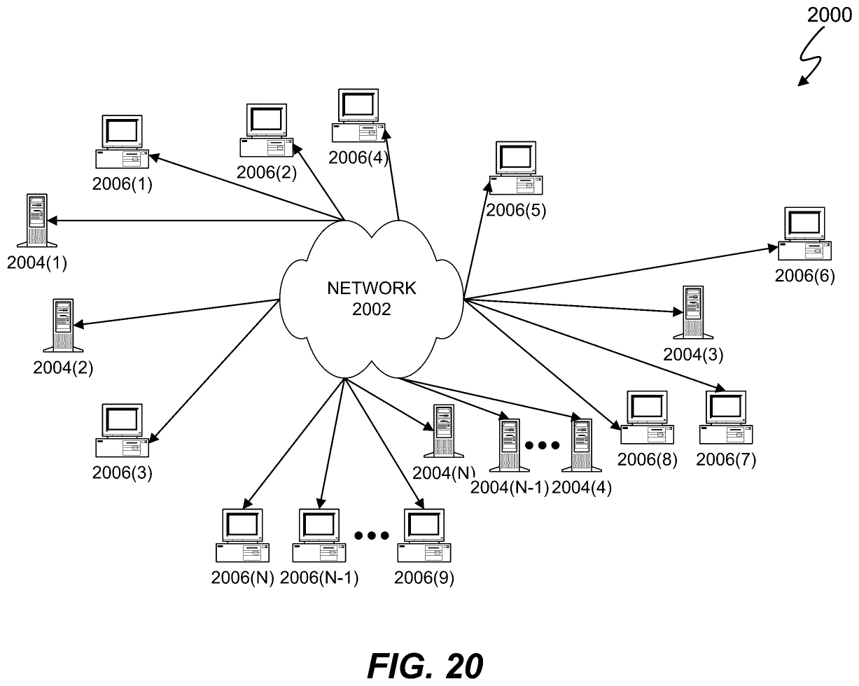

FIG. 20 is a block diagram illustrating a network environment in which a video response generation system 100 and video response generation process 200 may be practiced. Network 2002 (e.g. a private wide area network (WAN) or the Internet) includes a number of networked server computer systems 2004(1)-(N) that are accessible by client computer systems 2006(1)-(N), where N is the number of server computer systems connected to the network. Communication between client computer systems 2006(1)-(N) and server computer systems 2004(1)-(N) typically occurs over a network, such as a public switched telephone network over asynchronous digital subscriber line (ADSL) telephone lines or high-bandwidth trunks, for example communications channels providing TI or OC3 service. Client computer systems 2006(1)-(N) typically access server computer systems 2004(1)-(N) through a service provider, such as an internet service provider (“ISP”) by executing application specific software, commonly referred to as a browser, on one of client computer systems 2006(1)-(N).

Client computer systems 2006(1)-(N) and/or server computer systems 2004(1)-(N) are specialized computer programmed to improve conventional computer systems to implement and utilize the video response generation system 100 and video response generation process 200. The type of computer system that can be specially programmed to implement and utilize the video response generation system 100 and video response generation process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the video response generation system 100 and video response generation process 200 can be implemented using code stored in a tangible, non-transient computer readable medium and executed by one or more processors. In at least one embodiment, the video response generation system 100 and video response generation process 200 can be implemented completely in hardware using, for example, logic circuits and other circuits including field programmable gate arrays.

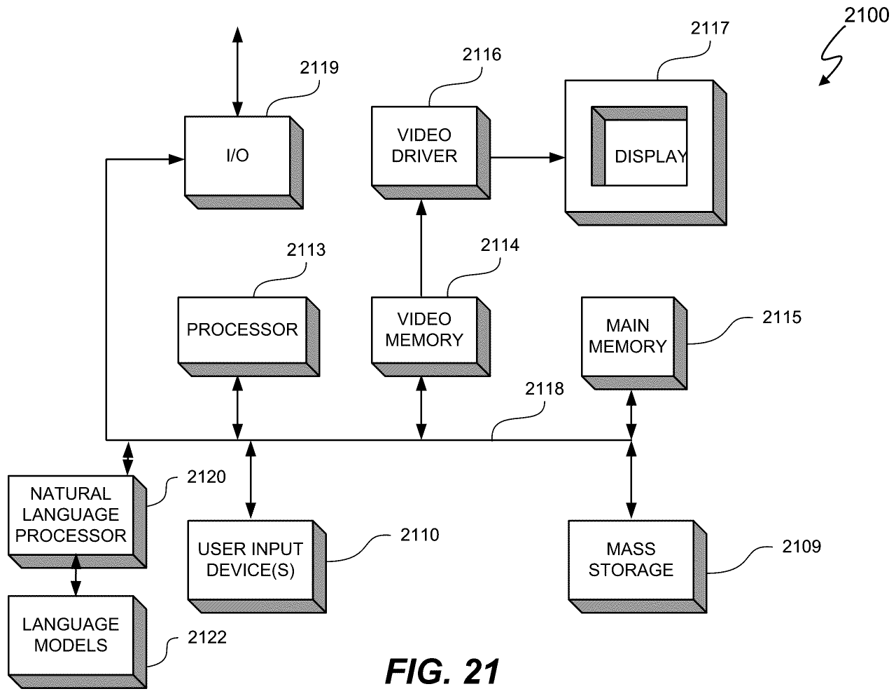

Embodiments of the video response generation system 100 and video response generation process 200 can be implemented on a computer system such as a special-purpose, special-programmed computer 2100 illustrated in FIG. 21. Input user device(s) 2110, such as a keyboard and/or mouse, are coupled to a bi-directional system bus 2118. The input user device(s) 2110 are for introducing user input to the computer system and communicating that user input to processor 2113. The computer system of FIG. 21 generally also includes a non-transitory video memory 2114, non-transitory main memory 2115, and non-transitory mass storage 2109, all coupled to bi-directional system bus 2118 along with input user device(s) 2110 and processor 2113. The mass storage 2109 may include both fixed and removable media, such as a hard drive, one or more CDs or DVDs, solid state memory including flash memory, and other available mass storage technology. Bus 2118 may contain, for example, 32 of 64 address lines for addressing video memory 2114 or main memory 2115. The system bus 2118 also includes, for example, an n-bit data bus for transferring DATA between and among the components, such as CPU 2109, main memory 2115, video memory 2114 and mass storage 2109, where “n” is, for example, 32 or 64. Alternatively, multiplex data/address lines may be used instead of separate data and address lines.

I/O device(s) 2119 may provide connections to peripheral devices, such as a printer, and may also provide a direct connection to a remote server computer systems via a telephone link or to the Internet via an ISP. I/O device(s) 2119 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 2109, into main memory 2115 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 2113, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 2115 is comprised of dynamic random access memory (DRAM). Video memory 2114 is a dual-ported video random access memory. One port of the video memory 2114 is coupled to video amplifier 2116. The video amplifier 2116 is used to drive the display 2117. Video amplifier 2116 is well known in the art and may be implemented by any suitable means. This circuitry converts pixel DATA stored in video memory 2114 to a raster signal suitable for use by display 2117. Display 2117 is a type of monitor suitable for displaying graphic images.

The computer system described above is for purposes of example only. The video response generation system 100 video response generation process 200 may be implemented in any type of computer system or programming or processing environment. It is contemplated that the video response generation system 100 and video response generation process 200 might be run on a stand-alone computer system, such as the one described above. The video response generation system 100 and video response generation process 200 might also be run from a server computer systems system that can be accessed by a plurality of client computer systems interconnected over an intranet network. Finally, the video response generation system 100 and video response generation process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for guiding and constraining an Artificial Intelligence (AI) engine to generate personalized video responses for a user comprising:
executing code using one or more processors of a computer system to cause the computer system to perform operations comprising:
receiving a user input from the user, wherein the user input identifies a historical figure from a predefined list of historical figures;
receiving a question input from the user, wherein the question input includes a query directed to the selected historical figure;
retrieving information relevant to the selected historical figure, wherein the relevant information comprises an image, a voice identifier, and a biographical profile of the selected historical figure;
utilizing a language learning model (LLM) to analyze the question input, wherein the LLM generates:
an excuse for any anticipated delay in responding to the question input;
a dialogue response formulated based on the biographical profile and historical context of the selected historical figure;
integrating the dialogue response with the relevant information retrieved for the selected historical figure to generate response, wherein the response includes:
an audio component incorporating the voice identifier and the dialogue response;
a visual component incorporating the image of the selected historical figure;
generating a prompt to guide and constrain the AI engine for generating a video response using a video generator, wherein the video response integrates the audio component and visual component to simulate the selected historical figure to deliver the dialogue response; and
transferring the prompt to the AI engine to provide the generated video response to the user on a user interface of an online learning platform.

2. The method of claim 1 wherein retrieving information relevant to the selected historical figure from a database, the database includes metadata categorizing the historical figures by historical period, geographical location, and achievements.

3. The method of claim 1 wherein the user interface provides the user to search historical figures from the database based on the name of the historical figures, time periods, or achievements.

4. The method of claim 1 further comprising:
a natural language processing model configured to parse the question input to identify the subject matter and context to enhance the relevance of the generated dialogue response.

5. The method of claim 1 wherein the LLM is trained on historical texts, speeches, and writings to ensure the generated dialogue response reflects the authentic speech patterns and perspectives of the selected historical figure.

6. The method of claim 1 wherein the video generator utilizes AI video synthesis techniques to animate the image of the historical figure, synchronizing lip movements with the generated dialogue response to create the realistic video response.

7. The method of claim 1 wherein the dialogue response generated by the LLM includes educational content designed to align with historical facts and provide informative answers to the user based on the question input.

8. The method of claim 1 wherein the generated video response is configured to cover topics within education standards associated with the user to assist the user in mastering the knowledge required on the online learning platform.

9. A system for guiding and constraining an Artificial Intelligence (AI) engine to generate personalized video responses for a user comprising:
one or more processors;
memory, coupled to the one or more processors, storing code that when executed cause the one or more processors to perform operations comprising:
executing code using one or more processors of a computer system to cause the computer system to perform operations comprising:
receiving a user input from the user, wherein the user input identifies a historical figure from a predefined list of historical figures;
receiving a question input from the user, wherein the question input includes a query directed to the selected historical figure;
retrieving information relevant to the selected historical figure, wherein the relevant information comprises an image, a voice identifier, and a biographical profile of the selected historical figure;
utilizing a language learning model (LLM) to analyze the question input, wherein the LLM generates:
an excuse for any anticipated delay in responding to the question input;
a dialogue response formulated based on the biographical profile and historical context of the selected historical figure;
integrating the dialogue response with the relevant information retrieved for the selected historical figure to generate response, wherein the response includes:
an audio component incorporating the voice identifier and the dialogue response;
a visual component incorporating the image of the selected historical figure;
generating a prompt to guide and constrain the AI engine for generating a video response using a video generator, wherein the video response integrates the audio component and visual component to simulate the selected historical figure to deliver the dialogue response; and
transferring the prompt to the AI engine to provide the generated video response to the user on a user interface of an online learning platform.

10. The system of claim 9 wherein retrieving information relevant to the selected historical figure from a database, the database includes metadata categorizing the historical figures by historical period, geographical location, and achievements.

11. The system of claim 9 wherein the user interface provides the user to search historical figures from the database based on the name of the historical figures, time periods, or achievements.

12. The system of claim 9 further comprising:
a natural language processing model configured to parse the question input to identify the subject matter and context to enhance the relevance of the generated dialogue response.

13. The system of claim 9 wherein the LLM is trained on historical texts, speeches, and writings to ensure the generated dialogue response reflects the authentic speech patterns and perspectives of the selected historical figure.

14. The system of claim 9 wherein the video generator utilizes AI video synthesis techniques to animate the image of the historical figure, synchronizing lip movements with the generated dialogue response to create the realistic video response.

15. The system of claim 9 wherein the dialogue response generated by the LLM includes educational content designed to align with historical facts and provide informative answers to the user based on the question input.

16.

17. The system of claim 9 wherein the generated video response is configured to cover topics within education standards associated with the user to assist the user in mastering the knowledge required on the online learning platform.
